(19) United States
(12) Patent Application Publication
(10) Pub. No.: US 2009/0284969 A1
(43) Pub. Date: Nov. 19, 2009

(54) LIGHT EMITTING DIODE LAMP

(75) Inventor: CHIA-SHOU CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/252,376

(22) Filed: Oct. 16, 2008

(30) Foreign Application Priority Data
May 16, 2008 (CN) 200810067260.5

(51) Int. Cl. F21V 7/00; F21V 31/00

(52) U.S. Cl. 362/241; 362/296.01; 362/267

(57) ABSTRACT

A light emitting diode lamp includes a mounting base, a number of light emitting diodes, and a reflecting cover. The mounting base includes opposite first and second surfaces, and an outer surface interconnecting outer peripheries of the first and second surfaces. Outer size of the outer surface of the mounting base decreases from the first surface to the second surface. At least one of the light emitting diodes is arranged on the second surface, with at least one arranged on the outer surface of the mounting base. The reflecting cover surrounds the mounting base for reflecting the light of the plurality of light emitting diodes towards one side of the reflecting wall facing the second surface of the mounting base.

### BACKGROUND

1. Field of the Disclosure

The disclosure generally relates to light emitting diode lamps, and particularly to a light emitting diode lamp with uniform light distribution.

2. Description of Related Art

In recent years, light emitting diodes (LED) have been widely used in illumination. However, the LED is a point light source, and an emitting surface thereof is usually hemispherical. Intensity of a light field of the LED decreases gradually and outwardly along a radial direction thereof. The intensity of the light field of the LED is uneven, being strong at a center of the light field of the LED and weak at the periphery of the light field of the LED.

For the foregoing reasons, therefore, there is a need in the art for an LED lamp which overcomes the limitations described.

### SUMMARY

According to an exemplary embodiment of the disclosure, a light emitting diode lamp includes a mounting base, a plurality of light emitting diodes, and a reflecting cover. The mounting base includes a first surface, a second surface opposite to the first surface, and an outer surface interconnecting outer peripheries of the first and second surfaces. An outer size of the outer surface of the mounting base decreases from the first surface to the second surface. At least one of the plurality of light emitting diodes arranged on the second surface of the mounting base, and at least one of the plurality of light emitting diodes arranged on the outer surface of the mounting base. The reflecting cover surrounds the mounting base for reflecting the light of the plurality of light emitting diodes towards one side of the reflecting wall facing the second surface of the mounting base.

Other advantages and novel features of the disclosure will be drawn from the following detailed description of the exemplary embodiments of the disclosure with attached drawings.

### BRIEF DESCRIPTION OF THE DRAWINGS

FIG. 1 is an assembled cross section of a light emitting diode lamp according to an exemplary embodiment.

FIG. 2 shows an isometric view of an alternative mounting base of the light emitting diode lamp.

### DETAILED DESCRIPTION OF THE EMBODIMENTS

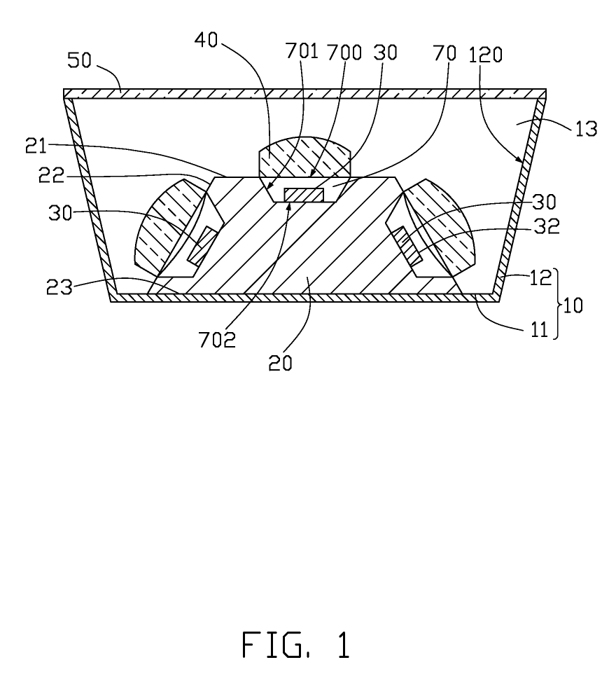

Referring to FIG. 1, a light emitting diode (LED) lamp according to an exemplary embodiment includes a reflecting cover 10, a mounting base 20, a number of LEDs 30, and a sealing cover 50. The reflecting cover 10 is hollow, and has an open top side and a closed bottom side. The open top side is larger than the closed bottom side. The closed bottom side of the reflecting cover 10 acts as a mounting side for arrangement of the LEDs 30, and the open top side of the reflecting cover 10 acts as an emitting side for emitting light of the LEDs 30 to the exterior. In this embodiment, the reflecting cover 10 is conversely truncated conical, and includes a circular bottom wall 11, and a reflecting wall 12 extending upwardly and integrally from a periphery of the bottom wall 11. The reflecting wall 12 expands along the extending direction, that is, along an axial orientation of the reflecting cover 10, and thus a diameter of an inner surface 120 of the reflecting wall 12 increases gradually along the axial orientation from the bottom wall 11 of the reflecting cover 10. The inner surface 120 is coated with a layer of material of high reflectivity, such as mercury, aluminum, silver, aurum or copper, to reflect the light of the LEDs 30 towards the open top side of the reflecting cover 10. The sealing cover 50 has a diameter substantially the same as that of the open top side of the reflecting cover 10, and couples to the open top side of the reflecting cover 10 to seal the top side of the reflecting cover 10. A space 13 is thus formed between the reflecting cover 10 and the sealing cover 50 receiving the mounting base 20 and the LEDs 30 therein. The sealing cover 50 is transparent material, such as resin or glass.

The mounting base 20 is received in the space 13 and mounted on the bottom wall 11 of the reflecting cover 10. A central axis of the mounting base 20 is collinear with that of the reflecting cover 10. The mounting base 20 is truncatedly conical. The mounting base 20 has a bottom surface 23 attached to the bottom wall 11 of the reflecting cover 10, an opposite top surface 21 facing the sealing cover 50, and an outer surface 22 interconnecting outer peripheries of the top surface 21 with the bottom surface 23. The bottom surface 23 and the top surface 21 of the mounting base 20 are circular, and a diameter of the bottom surface 23 exceeds that of the top surface 21. An area of a cross section of the mounting base 20 decreases gradually and linearly along the axial orientation thereof from the bottom surface 23 to the top surface 21. The outer surface 22 of the mounting base 20 is sectioned and annular in an unfurled view. A distance between the outer surface 22 of the mounting base 20 and the inner surface 120 of the reflecting wall 12 of the reflecting cover 10 in a radial direction increases gradually along the axial orientation from the bottom wall 11.

A number of blind holes 70 are defined in the mounting base 20 for arrangement of the number of LEDs 30. The blind holes 70 are separately arranged on the top surface 21 and the outer surface 22 of the mounting base 20, and spaced from each other. In the cross section of the LED lamp, two LEDs 30 are shown in the outer surface 22 and only one LED 30 is shown in the top surface 21 of the mounting base 20. It is to be understood that modality of the LEDs 30 of the LED lamp is predetermined, and the modalities of the LEDs 30 of different LED lamps should differ. Size and position of the blind holes 70 is determined according to the modality of the LEDs 30. In this embodiment, each blind hole 70 is conversely truncated conical. Each blind hole 70 forms a circular open end 700 at the outer surface 22/top surface 21 of the mounting base 20, a circular closed end 702 in the mounting base 20 for mounting the LEDs 30 thereon, and an annular sidewall 701 between the open end 700 and the closed end 702. The open end 700 of the blind hole 70 is larger than the closed end 702, and the sidewall 701 converges along a central axis of the blind hole 70 from the open end 700 to the closed end 702. The sidewall 701 is coated with a layer of material of high reflectivity, such as mercury, aluminum, silver, aurum or copper, for reflecting the light of the LEDs 30 to the open end 700.

Each LED 30 is received in one corresponding blind hole 70 of the mounting base 20 and has an emitting surface 32 facing the open end 700 of the blind hole 70. A number of lenses 40 are arranged on the mounting base 20 and seal the open ends 700 of the blind holes 70. Each lens 40 has a central axis collinear with the central axis of the corresponding blind hole 70, and the emitting surface 32 of the corresponding LED 30 faces the corresponding lens 40, thus a light emitting directionality of the LED 30 can be enhanced by the corresponding lens 40. When assembled, all of the LEDs 30 are mounted in the blind holes 70 of the base 20 with the lenses 40 arranged thereon, and then mounted onto the bottom wall 11 of the reflecting cover 10 together with the base 20 via the open top side of the reflecting cover 10. Finally the sealing cover 50 is coupled to the open top end of the reflecting cover 10 and forms a watertight seal between the sealing cover 50 and the reflecting cover 10. Thus all of the LEDs 30 can be assembled at the same time to form the LED lamp, and fabrication of the LED lamp is thus simple and fast.

When the LEDs 30 emit light, a majority of the light of the LEDs 30 arranged on the top surface 21 of the mounting base 20 passes across the lens 40 into the space 13 between the sealing cover 50 and the reflecting cover 10, and then across the sealing cover 50 to the exterior directly, and a remainder travels towards the inner surface 120 of the reflecting wall 12 after passing the lens 40. As the reflecting wall 12 expands upwardly along the axial orientation, with an angle between the inner surface 120 of the reflecting wall 12 and the top surface 21 of the mounting base 20 exceeding 90°, when the light of the LED 30 of the top surface 21 travels towards the inner surface 120 of the reflecting wall 12, the reflected light, symmetrical with incident light about the normal of the inner surface 120, is emitted towards the sealing cover 50. In addition, due to the inner surface 120 of the reflecting wall 12 being coated with high reflectivity material, nearly all incident light is reflected towards the sealing cover 50. Thus approximately all of the light of the LED 30 on the top surface 21 of the mounting base 20 can travel to the exterior.

In addition, the LEDs 30 arranged on the outer surface 22 of the mounting base 20 emit light during operation. Because the outer surface 22 of the mounting base 20 faces the inner surface 120 of the reflecting wall 12 of the reflecting cover 10, only a small part of the light of the LEDs 30 of the outer surface 22 travels to the sealing cover 50 directly after passing the lens 40, and a large part of the light of the LEDs 30 of the outer surface 22 travels to the inner surface 120 of the reflecting wall 12. As an angle between the inner surface 120 of the reflecting wall 12 and outer surface 22 of the mounting base 20 is less than 90°, almost all of the larger part of the light of the LEDs 30 of the outer surface 22 travels towards the reflecting wall 12, and is then reflected towards the sealing cover 50. Thus all of the light of the LEDs 30, either on the top surface 21, or on the outer surface 22 of the mounting base 20, can be reflected towards the sealing cover 50 and finally to the exterior. The direction of all of the light is towards the sealing cover 50, such that the LEDs 30 act as a surface light source. Intensity of the light field of the LED lamp is thus substantially even.

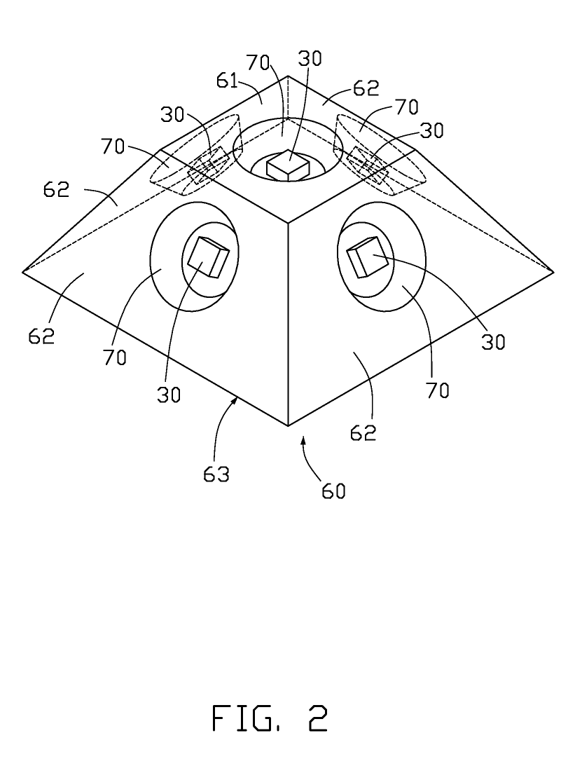

The LED lamp may be embodied in other forms without departing from the spirit of the disclosure. FIG. 2 shows an alternative embodiment of the of the LED lamp differing from the previous embodiment only in that the mounting base 60 is shaped as a truncated pyramid. A top surface 61 and a bottom surface 63 of the mounting base 60 is square, with the bottom surface 63 being larger than the top surface 61. The outer surface of the mounting base 60 includes four trapezoidal side surfaces 62. Each side surface 62 defines at least one blind hole 70 for mounting of the LEDs 30, and at least one blind hole 70 is defined in the top side 61 of the mounting base 60 receiving one LED 30 therein. As described in the embodiments, the LEDs can be arranged on the top surface and the side surface of the mounting base, and area for mounting the LEDs is increased, and thus the amount of the LEDs arranged on the base is improved. Intensity of the light field of the LED lamp is accordingly enhanced and substantially even.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A light emitting diode lamp, comprising:
a mounting base having a first surface, a second surface opposite to the first surface, and an outer surface interconnecting outer peripheries of the first and second surfaces, an outer size of the outer surface decreasing from the first surface to the second surface;
at least one light emitting diode arranged on the second surface of the mounting base for emitting light;
at least one light emitting diode arranged on the outer surface of the mounting base for emitting light; and
a reflecting cover surrounding the mounting base for reflecting the light of the light emitting diodes towards one side of the reflecting wall facing the second surface of the mounting base.

2. The light emitting diode lamp of claim 1, wherein a number of blind holes extend into the mounting base from the second surface and the outer surface of the mounting base, each blind hole receiving one corresponding light emitting diode therein.

3. The light emitting diode lamp of claim 2, wherein each blind hole is conversely truncated conical, comprising an open end for emitting the light of the light emitting diode, an opposite closed end for mounting the one corresponding light emitting diode, and a sidewall between the open end and the closed end, the open end being larger than the closed end, the sidewall surrounding the one corresponding light emitting diode and coated with a layer of reflecting material for reflecting the light of the one corresponding light emitting diode towards the open end.

4. The light emitting diode lamp of claim 3, wherein a lens is coupled to the open end of the blind hole for enhancing light emitting directionality of the one corresponding light emitting diode.

5. The light emitting diode lamp of claim 1, wherein the reflecting cover comprises a bottom wall and a reflecting wall extending outwardly from a periphery of the bottom wall, the first surface of the mounting base attaching to the bottom wall, an inner surface of the reflecting wall facing the outer surface of the mounting base and coated with a layer of reflecting material.

6. The light emitting diode lamp of claim 5, wherein the inner surface of the reflecting wall expands along an axial orientation from the bottom wall.

7. The light emitting diode lamp of claim 5, wherein a transparent sealing cover couples to a top side of the reflecting cover, the inner surface of the reflecting wall reflecting the light of the light emitting diodes towards the sealing cover.

8. The light emitting diode lamp of claim 1, wherein the mounting base is truncatedly conical, and the first and second surfaces of the mounting base are circular.

9. The light emitting diode lamp of claim 1, wherein the mounting base is truncatedly pyramidical, and first and second surfaces of the mounting base are square.

10. A light emitting diode lamp, comprising:
a hollow reflecting cover having a first side and an opposite second side, an inner surface of the reflecting cover between the first and second side being coated with a layer of reflecting material;
a mounting base located at the first side of the reflecting cover and being surrounded by the inner surface of the reflecting cover, a distance between the inner surface of the reflecting cover and an outer surface of the mounting base increasing gradually from the first side to the second side of the reflecting cover; and
at least one light emitting diode arranged on the outer surface of the mounting base and facing the inner surface of the reflecting cover.

11. The light emitting diode lamp of claim 10, wherein the base is truncatedly pyramidical, and the inner surface of the reflecting cover expands from the first side to the second side.

12. The light emitting diode lamp of claim 10, wherein the base is truncatedly conical, and the inner surface of the reflecting cover is conversely truncated conical.

13. The light emitting diode lamp of claim 10, wherein the first side of the reflecting shell is closed, the second side of the reflecting shell is open, a transparent sealing cover couples to the open second side of the reflecting cover, and the inner surface of the reflecting cover extends integrally and outwardly from the closed first side to the second side for reflecting the light of the at least one light emitting diode towards the open second side.

14. The light emitting diode lamp of claim 13, wherein the base includes a bottom surface attaching to the closed first side of the reflecting cover, an opposite top surface facing the sealing cover, the outer surface of the mounting base located between the bottom surface and the top surface, and the light emitting diode lamp further comprises at least one light emitting diode arranged on the top surface of the mounting base.

15. The light emitting diode lamp of claim 14, wherein a plurality of mounting holes are defined in the top surface and the outer surface of the mounting base receiving the light emitting diodes therein.

16. The light emitting diode lamp of claim 15, wherein each hole is conversely truncated conical, comprising an open end for emitting the light of a corresponding light emitting diode, an opposite closed end for mounting the corresponding light emitting diode thereon and a sidewall between the open end and the closed end, the open end being larger than the closed end, the sidewall surrounding the corresponding light emitting diode coated with a layer of reflecting material.

17. The light emitting diode lamp of claim 10, wherein the reflecting material is mercury, aluminum, silver, aurum, or copper.
